(19) United States
(12) Patent Application Publication
(10) Pub. No.: US 2010/0002235 A1
(43) Pub. Date: Jan. 7, 2010

(54) LASER DIODE ARRANGEMENTS AND METHOD FOR GAS DETECTION

(75) Inventors: Bert WILLING, Blonay (CH); Markus KOHLI, Grandson (CH); Andreas SEIFERT, Denens (CH)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(73) Assignee: IRMicrosystems SA, Lausanne (CH)

(21) Appl. No.: 12/350,331

(22) Filed: Jan. 8, 2009

(30) Foreign Application Priority Data
Jul. 7, 2008 (EP) 08012232.8

(51) Int. Cl. G01N 21/00; H01S 3/04

(52) U.S. Cl. 356/437; 372/34

(57) ABSTRACT

A gas detection laser diode device and gas detection unit including the gas detection laser diode device having a hermetically sealed housing with electrical connectors at the bottom and a window, and inside the housing a laser diode and thermistor mounted on one stage of a thermo element. The thermo element is connected with the other stage to the base of the housing. Collimating means are arranged in the laser beam between the laser diode and the window. The window is tilted in respect to the axis of the laser beam such, that the ordinary reflection of the laser beam is steered off the laser beam axis and at least does not impinge on the laser diode. Preferably the collimating means and the laser diode are mounted on a same surface for holding them on the same temperature. The new device allows the detection of toxic gases with reduced detection limits over the prior art. The arrangement further claims a method to achieve reduced detection limits for gases.

### CROSS-REFERENCE TO RELATED APPLICATION

The present application claims priority under 35 USC §119 to European Patent Application No. 08 012 232.8, filed on Jul. 7, 2008, the entire disclosure of which is incorporated herein by reference.

### TECHNICAL FIELD OF THE INVENTION

The present invention concerns a gas detection laser diode device comprising a hermetically sealed housing with electrical connectors at the bottom and a window, and inside said housing a laser diode and a thermistor mounted to one stage of a thermoelement, which is connected with the other stage of the base of said housing, wherein the laser beam emitted by that laser diode passes through said window. The invention further concerns a method for generating a laser beam for gas detection in a respective laser diode arrangement and a gas detection unit comprising the gas detection laser diode arrangement.

### DESCRIPTION OF THE RELATED ART

For tunable laser gas detection (TDLS), the long coherence length of the laser diodes raises the problem of interferences of the main light beam with fractions of the beam which have travelled along a different path. Typical examples are the backreflections from interposed optical surfaces (window, lenses) or other mechanical components. At constant temperature, these interference patterns (“etalon fringes”, or “etalons”) do not change and can be subtracted from the measured gas concentration as a simple offset. However, as ambient temperature changes, so does the mechanical size of the various possible light paths due to the thermal expansion coefficient of the employed materials. On typical lengths in the order of centimetres, the change in length due to a change in temperature of a few degrees centigrade easily is in the order of a wavelength. With such changes in temperature, the etalon therefore changes significantly and creates thus a peak-to-peak noise on the gas concentration signal, which cannot be compensated. In fact, all known TDLS instruments have their ultimate detection limit for gas concentrations limited by the etalon signal.

A typical mounting of a laser diode comprises a base for the assembly, which is hermetically sealed (so-called TO-header), which has electrical feed-throughs at its bottom end, and a window at its top end. The hermetical sealing of the package is mandatory in order to avoid the exposure of the laser die to potentially aggressive gases or to moisture as well as environment convection. A main point of the packaging is a very precise stabilization and control of the laser diode temperature, which has to be maintained at a given value for a given wavelength. A variation of the temperature would change the laser wavelength so that the target gas could no longer be detected. The laser diode chip is glued, together with a thermistor for temperature control, to a submount. The submount in turn is glued to the “cold stage” of a Peltier element. The “hot stage” of the Peltier element is connected to the TO-header, which also acts as the heat sink for the Peltier element.

For the detection of toxic gases, very low detection limits are required. For example, the detection of 1 ppm ammonia requires the TDLS instrument to measure the absorption of 3 ppm of the initial laser intensity. If, on the other hand, 3 ppm of the laser light intensity travels on a different path of the main light beam and interferes with the latter on the detecting photodiode, the resulting etalon signal due to temperature variation corresponds to a noise level of 1 ppm ammonia.

The near infrared laser diodes used for TDLS (700 nm-2,700 nm) typically show a very divergent beam due to their short cavity length. The full width half maximum angle of 20-40°, together with a physical length of several centimetres for the gas absorption path, makes it extremely difficult to avoid stray light reflections generating etalons. Moreover, the laser diode needs to be hermetically sealed off from the potentially aggressive environment by a window, and the backreflections from this window to the laser diode cause an etalon signal which is the most difficult one to remove.

The tilting of the laser cap window, and/or a high-performance antireflection coating does not allow to suppress the etalon signal induced by the window to an acceptable level. This is due to the fact that with the large divergence angle of the laser, there will always be a part of the laser beam reflected back. Additionally, although very high performance coating limit the backreflection to 0.05%, this still equals 500 ppm of the light intensity and is about two orders of magnitude above an acceptable level for i.e. ammonia detection.

### SUMMARY OF THE INVENTION

In view of this, it is the object of the present invention to provide laser diode arrangements and method for TTLS with reduced detection limits for gas concentration in the range of 1 ppm or less having an enhanced optical noise suppression.

This problem is solved by the gas detection laser diode device, the gas detection unit and the method as claimed. Further advantages features are described in the respective subclaims.

According to the invention, the gas detection laser diode device comprises collimating means arranged in the laser beam between said laser diode and said window, said window is tilted in respect to the axis of said laser beam, such, that the ordinary reflection of the laser beam is steered off the laser beam axis and at least does not impinge on the laser diode. Due to the collimation of the laser beam a well-defined path is created and any reflections from optical interfaces can be designed by a proper angling of such surfaces. The various reflections of a divergent beam off any mechanical or optical components (edges, screws, walls) cannot be controlled or designed. Since, as explained above, the most disturbing etalon signal is created by backreflections inside the TO-header of the laser diode, it is therefore a most important feature that the laser beam is collimated inside the TO-header before it exits the laser window, which seals off the TO-header.

Further, the window of the TO-header is tilted in respect to the axis of the laser beam, so that the ordinary reflection of the laser beam is steered off the laser beam axis. Thus, interferences between the main laser beam and the ordinary reflection are avoided. A change of the distance between collimation device and window due to the thermal expansion coefficient of the TO-header will therefore not generate an etalon signal, independent, whether a horizontally emitting laser (i.e. DFB laser) or a vertically emitting laser (VCSEL) is used.

According to a preferred embodiment of the invention the collimating means and the laser diode are mounted on a same surface. The surface can be a submount, for other appropriate means, i.e. the surface of the next necessary element (Peltier element). This keeps the collimating means and the laser diode on the same temperature and avoids a major problem, which resides in the thermal distance variation between the collimation lens and the laser diode. Due to the very principle of collimation by a lens, there will be always a regular backreflection from one of the lens surfaces to the laser diode, thus creating an etalon signal under variations of the ambient temperature. The ambient temperature (which is identical to the temperature of the heat sink) may vary in a range as wide as from −50° C. to +65° C. A distance of 1 mm between laser diode and lens, established by a mechanical mounting, will undergo a thermal expansion of 10% of the laser wavelength for a change of the ambient temperature of 10° C. This, together with large solid angle created by the short distance between laser diode and backreflecting surface, gives rise to large etalon signals. Therefore a window in lens shape, which would at the same time seal the laser package and perform a collimation, is therefore not at all appropriate.

In order to avoid the thermal expansion between laser diode and collimating lens, both are kept on the same temperature, i.e. the set temperature of the laser diode. This requires the collimating means, preferably a lens, and its mount to be mounted on the same surface as the laser diode (i.e. laser submount or directly “cold stage” of the Peltier element). A variation of the temperature stabilization could be a heated submount. In this case, the temperature stabilization cannot be achieved by cooling and the laser has therefore to be stabilized slightly above the maximum operating temperature of the gas sensor.

In such a configuration, the possible direct backreflections of the laser beam into the laser diode chip should to be avoided. Apart from the conventional etalon signal, the laser diode represents a non-linear optical device and reacts very sensitively to the input of light. A backreflection of parts of the emitted light beam into the laser cavity would give rise of an internal self-mixing, and this self-mixing would translate into laser instability and high intensity noise.

For avoiding of the backreflections according to an embodiment, the space between laser diode and lens is index-matched, for example by the suppression of one of the optical interfaces of the lens. Therefore, one possibility are collimating means in form of a rod lens with a convex upper surface which also can be formed by a ball lens attached with a glue of the index of reflection of said ball lens directed to the laser chip. However, such an assembly has the disadvantage of not-known ageing effects between the glue between laser diode and lens and the laser diode, and the glue and the lens.

According to a further preferred embodiment of the invention the lens is a micro mechanical lens of appropriate material, e.g. glass, silicon or plastics, with anti-reflective coating. A high-performance anti-reflective coating of the lens surfaces with typically less than 0.5% reflection at the wavelength of interest avoids such backreflections.

According to a further preferred embodiment the axis of the laser beam is offset to the axis of the collimating means. To avoid backreflection further requires that the lens is laterally de-centered (typically by a couple of 10 micrometers) from the laser diode aperture in order to avoid that surfaces having a tangent parallel to the laser diode surface are not directly opposite from the laser diode aperture, which also would lead to backreflections. The aperture of the laser chip is slightly lateral off the focus of the micro-lens.

In general it is possible to provide the lens directly on to the aperture of the laser diode. This may have disadvantages concerning the aging problem by arranging the lens directly on to the laser diode chip. By using glue between the lens and the laser diode chip shrinking during curing and over the time might produce stress. In case that the lens is too far away from the laser diode, parts of the emitted laser beam do not impinge onto the lens and are not collimated therefore creating etalons. However, possibilities of lens mounting with a very short distance are the use of a spacer, which also can work as a mirror in case of a DFB laser, or, for example, a micro-lens suspended by any other means above the laser chip (i.e. a ball lens fixed in a tripod stand which in turn is fixed to the submount, or a plastic injection moulded assembly in such a form). Another variation of the lens mounting could be a lens formed by micro machining directly on the laser aperture of the laser chip, i.e. by micro-etching the laser material, or by integrating a drop of polymer or another material onto the top of the laser chip.

However, it is preferred, that there is a slight distance between the laser chip and the lens to avoid above mentioned influence of glue and ageing.

The gas detection laser diode device is normally arranged in a gas detection unit comprising a housing including a laser head and a sample chamber for the gas to be detected and sensor means for the laser beam emitted by the laser diode and travelled through the gas in the sample chamber.

Further features of the invention can be found in the following description of preferred embodiments of the invention in connection with the claims and the drawings. The single features can be realised alone or several together in embodiments of the invention.

### BRIEF DESCRIPTION OF THE DRAWINGS

FIG. 1 the principal arrangement of a laser diode device;

FIG. 2 an enlarged depiction of a mounting arrangement for collimation of a vertically emitting laser;

FIG. 3 an enlarged depiction according to FIG. 2 with a mounting arrangement for collimation of a horizontally emitting laser; and

FIG. 4 a gas sensing unit comprising a laser diode device.

### DETAILED DESCRIPTION OF THE INVENTION

FIG. 1 shows a typical mounting of a laser diode 1 in a hermetically sealed TO-header 2, which has electrically feed-troughs 3 at its bottom end. The laser diode chip 1 is glued, together with a thermistor 4 for temperature control to a submount 5. The submount in turn is glued to the cold stage of a Peltier element 6. The hot stage of the Peltier element 6 is connected to the TO-header 2, which also acts as the heat sink for the Peltier element 6. On top of the TO-header 2 is a tilted window 7 for the laser beam 8 emitted from the laser diode on the laser diode chip 1. Between the laser diode chip 1 and the tilted window 7 there are collimation means 9 for providing a collimated laser beam 8 passing through the tilted window 7. The window 7 is tilted in respect to the axis of the laser beam 8 such, that the ordinary reflection 8′ of the laser beam 8 is steered off the laser beam axis, so that interferences between the main laser beam 8 and the ordinary reflection 8′ are avoided. A change of the distance between the collimation means 9 and the window 7 due to the thermal expansion coefficient of the TO-header 2 will not generate an etalon signal by an appropriate tilting of the window 7 in relation to the distance between the laser diode chip 1 and the window 7.

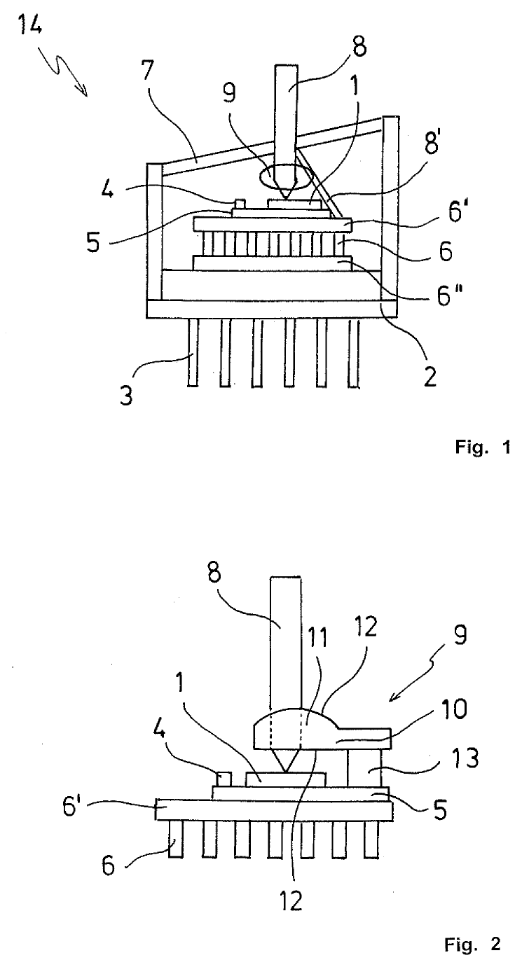

FIG. 2 shows an example of the collimation means 9 comprising a micro machined silicone lens 10 with a convex upper surface 11. The surfaces of the collimation means are covered with a high performance anti-reflective coating 12, having a reflection less than 0.5% at the wavelength of interest. As shown in FIG. 2 and FIG. 3 the lens 10 is laterally de-centered (typically by a couple of 10 micrometers) from the laser diode aperture in order to avoid that surfaces having a tangent parallel to the laser diode surface are not directly opposite from the laser diode aperture. By this feature the aperture of the laser chip is slightly off the focus of the micro-lens 10 in at least one dimension. The distance between the lens 10 and the laser diode chip 1 is realized by a spacer 13. The distance between the lens 10 and the surface of the laser diode on the laser diode chip 1 is defined by the refractive index of the lens 10. For example, with a ball lens having a refractive index of 1.5, the distance between lens 10 and laser diode chip 1 has to be 123 μm. A smaller refractive index requires a larger distance with the risk, that parts of the laser beam emitted from the laser diode do not impinge on the lens 10.

While FIG. 2 shows a vertical cavity surface emitted laser (VCSEL), FIG. 3 shows a distributed feed back (DFB) laser, so that the spacer 13 has to be designed additionally as mirror in order to reflect the laser beam emitted by the laser diode on the laser diode chip 1 to the lens 10.

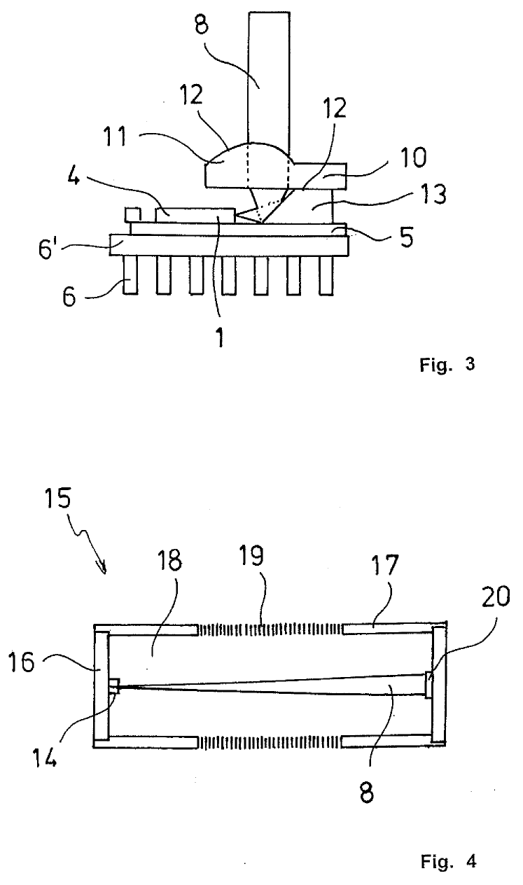

FIG. 4 shows a principal gas detection unit 15 comprising a gas detection laser diode device 14 arranged in a laser head 16 of a housing 17. The housing 17 has a sample chamber or gas detection region 18 with gas inlet 19 for the gas to be detected through which the laser 8 provided by the gas detection diode device 14 pass through. A light sensor 20 receives the laser beam 8 and provides a signal for further processing.

Unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

1. A gas detection laser diode device, comprising:
a hermetically sealed housing with electrical connectors at the bottom and a window, and inside said housing a laser diode and a thermistor mounted to one stage of a thermo-element, which is connected with the other stage to the base of said housing, wherein the laser beam emitted by said laser diode passes through said window,
collimating means arranged in the laser beam between said laser diode and said window, said window is tilted in respect to the axis of said laser beam such, that the ordinary reflection of the laser beam is steered off the laser beam axis and at least does not impinge on the laser diode.

2. The device according to claim 1, wherein said collimating means and said laser diode are mounted on a same surface.

3. The device according to claim 1, wherein said collimating means is a rod lens with a convex upper surface.

4. The device according to claim 3, wherein the convex upper surface includes an anti-reflective coating.

5. The device according to claim 2, wherein said collimating means is a rod lens with a convex upper surface.

6. The device according to claim 5, wherein the convex upper surface includes an anti-reflective coating.

7. The device according to claim 1, wherein said collimating means is a lens with anti-reflective coating.

8. The device according to claim 7, wherein the lens is a micromechanical lens.

9. The device according to claim 2, wherein said collimating means is a lens with anti-reflective coating.

10. The device according to claim 9, wherein the lens is a micromechanical lens.

11. The device according to claim 1, wherein said axis of the laser beam is offset to the axis of said collimating means.

12. A gas detection unit comprising a housing including a laser head with a gas sensing laser diode device according to claim 1 and a sample chamber for the gas to be detected and sensor means for the laser beam emitted by the laser diode of the gas sensor laser diode device and travelled through the gas in the sample chamber.

13. A method for generating a laser beam for gas detection in a laser diode arrangement including a hermetically sealed housing with electrical connectors at the bottom and a window, and inside said housing a laser diode and a thermistor mounted to one stage of a thermo element, which is connected with the other stage to the base of said housing, wherein the laser beam emitted by said laser diode passes through said window, comprising:
tilting said window in respect to the axis of said laser beam such said the ordinary reflection of the laser beam is steered off the laser beam axis and at least does not impinge on the laser diode, and
collimating said laser beam by collimating means before reaching said tilted window.

14. The method according to claim 13, comprising keeping said collimating means and said laser diode on the same temperature.

15. The method according to claim 13, comprising providing a collimating lens as collimating means, laterally de-centering said collimating lens from the aperture of the laser diode.

16. The method according to claim 14, comprising providing a collimating lens as collimating means, laterally de-centering said collimating lens from the aperture of the laser diode.
